(19) United States
(12) Patent Application Publication
(10) Pub. No.: US 2019/0244104 A1
(43) Pub. Date: Aug. 8, 2019

(54) Method for improving computations of correlation values between surface roughness and terrain parameters

(71) Applicant: Macau University of Science and Technology, Macau (CN)

(72) Inventors: Zhanchuan Cai, Macau (CN); Aiju Li, Macau (CN)

(21) Appl. No.: 15/886,860

(22) Filed: Feb. 2, 2018

(51) Int. Cl. G06N 3/08; G06F 17/16

(52) U.S. Cl. CPC G06N 3/084; G06F 17/156; G06F 17/16

(57) ABSTRACT

One embodiment is a method that improves computations of correlation values between a surface roughness and terrain parameters of a terrain surface. The method includes applying the terrain parameters as an input of a Back Propagation Neural Network (BPNN) and the surface roughness as an output of the BPNN; implementing a nonlinear mapping from the input to the output of the BPNN; generating a weight matrix (ω₁) and a weight matrix (ω₂); and improving computations of the correlation values by calculating a correlation matrix by ω₂×ω₁, calculating a unit weight which is a sum of absolute values in the correlation matrix, and dividing each value in the correlation matrix by the unit weight.

### FIELD OF THE INVENTION

The present invention relates to methods and apparatus that improve computations and accuracy of correlation values between surface roughness and terrain parameters including slope, aspect, curvature, plane curvature, slope variability and aspect ratio.

### BACKGROUND

Surface roughness is a useful measure of the lunar surface texture. It plays an important role in terrain analysis, such as characteristics of landing site, distribution of various fragments and extraction of typical texture. Thus, it provides important clues to understand the features of planetary surfaces. Correlation analysis between lunar roughness and other terrain factors is one of scientific objectives of current Moon research. Different factors reflect the topographic features by their different forms, which are sensitive to the formulations and algorithms for extracting these basic parameters from DEMs. Different Terrain factors are useful measure of the lunar surface texture and have close relationship among them. New methods and apparatus that assist in advancing technological needs and industrial applications in effective computation of correlation values between surface roughness and terrain parameters are desirable.

### SUMMARY OF THE INVENTION

One example embodiment is a method that improves computations of correlation values between a surface roughness and terrain parameters of a terrain surface. The method includes applying the terrain parameters as an input of a Back Propagation Neural Network (BPNN) and the surface roughness as an output of the BPNN; implementing a nonlinear mapping from the input to the output of the BPNN; generating a weight matrix (ω₁) and a weight matrix (ω₂); and improving computations of the correlation values by calculating a correlation matrix by ω₂×ω₁, calculating a unit weight which is a sum of absolute values in the correlation matrix, and dividing each value in the correlation matrix by the unit weight. The BPNN includes an input layer, a hidden layer and an output layer. The weight matrix (ω₁) are weights between the input layer and the hidden layer. The weight matrix (ω₂) are weights between the hidden layer and the output layer.

Another example embodiment is a computer system that generates an improved correlation graph that shows correlations between a surface roughness and terrain parameters of a lunar surface. The computer system includes a processor, a display, a non-transitory computer-readable medium. The non-transitory computer-readable medium has instructions stored therein that when executed cause the processor to apply the terrain parameters as an input of a Back Propagation Neural Network (BPNN) and the surface roughness as an output of the BPNN, wherein the BPNN includes an input layer, a hidden layer and an output layer; implement a nonlinear mapping from the input to the output of the BPNN; generate a weight matrix (ω₁) between the input layer and the hidden layer and a weight matrix (ω₂) between the hidden layer and the output layer; compute correlation values and generate the improved correlation graph on the display by plotting the correlation values against the terrain parameters. The correlation values are computed by calculating a correlation matrix by ω₂×ω₁; calculating a unit weight which is a sum of absolute values in the correlation matrix; and dividing each value in the correlation matrix by the unit weight.

Another example embodiment includes a method that generates an improved correlation graph that shows correlations between a surface roughness and terrain parameters of a lunar surface. The method includes applying, by the computer system, the terrain parameters as an input of a Back Propagation Neural Network (BPNN) and the surface roughness as an output of the BPNN; implementing, by the computer system, a nonlinear mapping from the input to the output of the BPNN; generating, by the computer system, a weight matrix (ω₁) between the input layer and the hidden layer and a weight matrix (ω₂) between the hidden layer and the output layer; computing, by the computer system, correlation values and generating, by the computer system and on a display, the improved correlation graph by plotting the correlation values against the terrain parameters. The BPNN includes an input layer, a hidden layer and an output layer. The correlation values are computed by calculating a correlation matrix by ω₂×ω₁; calculating a unit weight which is a sum of absolute values in the correlation matrix; and dividing each value in the correlation matrix by the unit weight.

Other example embodiments are discussed herein.

### BRIEF DESCRIPTION OF THE DRAWINGS

FIG. 1 shows a method that improves computations of correlation values between a surface roughness and terrain parameters of a terrain surface in accordance with an example embodiment.

FIG. 2 shows a global roughness map with the resolution of 16 pixels per degree in accordance with an example embodiment.

FIG. 3 shows topological structure of Back Propagation Neural Network (BPNN) in accordance with an example embodiment.

FIG. 4 shows fourteen different regions of lunar with geographical positions sampled in accordance with an example embodiment.

FIG. 5 shows data of Mare Orientale which is standardized and used in accordance with an example embodiment.

FIG. 6 shows the weights of each factor divided by the unit weight for unitization as the correlation values between each input factors and the surface roughness respectively in accordance with an example embodiment.

FIG. 7A to FIG. 7F show correlations in relationship % between surface roughness and terrain parameters for Mare Orientale, Mare Serenitatis, Mare Crisium, Mare Imbrium, Mare Humorum, Mare Nectaris respectively in accordance with an example embodiment.

FIG. 8A to FIG. 8H show correlations in relationship % between surface roughness and terrain parameters for Oceanus Procellarum, Tycho Crater, Copernicus Crater, Jackson Crater, Hertzsprung Basin, Freundlich-Sharonov, Coulomb-Sarton and Korolev in accordance with an example embodiment.

FIG. 9 shows a computer system reduces central processing unit (CPU) time to process instructions that generates an improved correlation graph that shows correlations between a surface roughness and terrain parameters of a lunar surface in accordance with an example embodiment in accordance with an example embodiment.

### DETAILED DESCRIPTION

Example embodiments relate to apparatus and methods that improve computations and accuracy of correlation values between a surface roughness and terrain parameters of a terrain surface.

With the successful launch of the lunar moons of Japan (Kaguya-1) (2007), China's Chang'e-I (2007), India's Chandrayaan-I (2008) and the US Lunar Reconnaissance Orbiter, lunar scientific research has become popular. Some correlations among the terrain factors are shown from their results. However, the mean-slope and mean-elevation data cannot represent all the data.

Example embodiments assist in applications based on the digital elevation model (DEM) data from different lunar areas using factors including slope, aspect, curvature (kv), plane curvature (kh), slope variability (SOS) and aspect ratio (SOA) and surface roughness, and relationship between them.

In order to extract the properties of surface roughness accurately, Morphological Surface Roughness (MSR) method is used in example embodiments. MSR method is successful for global lunar surface roughness mapping and for calculating the surface roughness of typical areas on the lunar surface. This surface roughness method is defined as the difference of the generated DEMs with morphological closing and opening operators, which are often constructed by finding the highest and lowest points reached by a shape called Structuring Element (SE). This method simplifies the computation in huge source data. The calculation of surface roughness by MSR method reduces the time of computation in huge source data using simple Structuring Elements (SE) and improves the accuracy of the model of the terrain surface. Global and regional roughness maps are built with different resolutions based on the morphological method.

One or more example embodiments calculate, by means of Back Propagation Neural Network (BPNN) with one hidden layer, the correlation values between lunar surface roughness obtained by MSR method and other terrain parameters. BPNN provides a reasonable nonlinear approximation of topographic complexities. The three layer BPNN network with six-dimension input and one hidden layer are constructed by taking nonlinearity into account with sigmod functions. Once trained, the method quickly simulates outputs from the inputs and the predicted outputs that are very close to the actual results. That is, once trained, the lunar roughness that inversed speedily with slope, aspect, curvature, plane curvature, slope variability and aspect ratio is very close to the actual output of the MSR method. Thus, BPNN network is trained with the corresponding parameters from each lunar area. Because the BPNN training for every region is continuous, the latter weight value may be impacted by the former weight value. The standardized correlation values are not very random, but the correlation is in fact the relative ratio which is used to test the compactness degree of relationship. Thus, example embodiments assist in advancing technological needs.

Example embodiments prove reliability of methods executed by a computer system that generates an improved correlation graph when compared with conventional correlation graphs using conventional techniques. The improved correlation graph shows correlations between a surface roughness and terrain parameters of a terrain surface. Fourteen areas are derived from lunar DEMs as the datum. The improved correlation graphs obtained in example embodiments are shown to have consistent trends among different areas. The results suggest that surface roughness have similar correlations with the changes of the given training set. Thus, the surface roughness can be applied to estimate other terrain parameters by using the BPNN method in the example embodiments.

Example embodiments detect the association feature of lunar topography quantitative factors by three-layer BPNN and determine the weight values between the input and output factors. The three-layer BPNN includes an input layer, a hidden layer and an output layer. The input layer and the hidden layer have a set of weights and there is also a corresponding set of weights between the hidden layer and the output layer. According to the two sets of weights, the relationship between the input terrain parameters and the output surface roughness are found. Thus, Example embodiments provide a methodology in lunar terrain factors analysis and in the estimation of the relevancy between terrain factors.

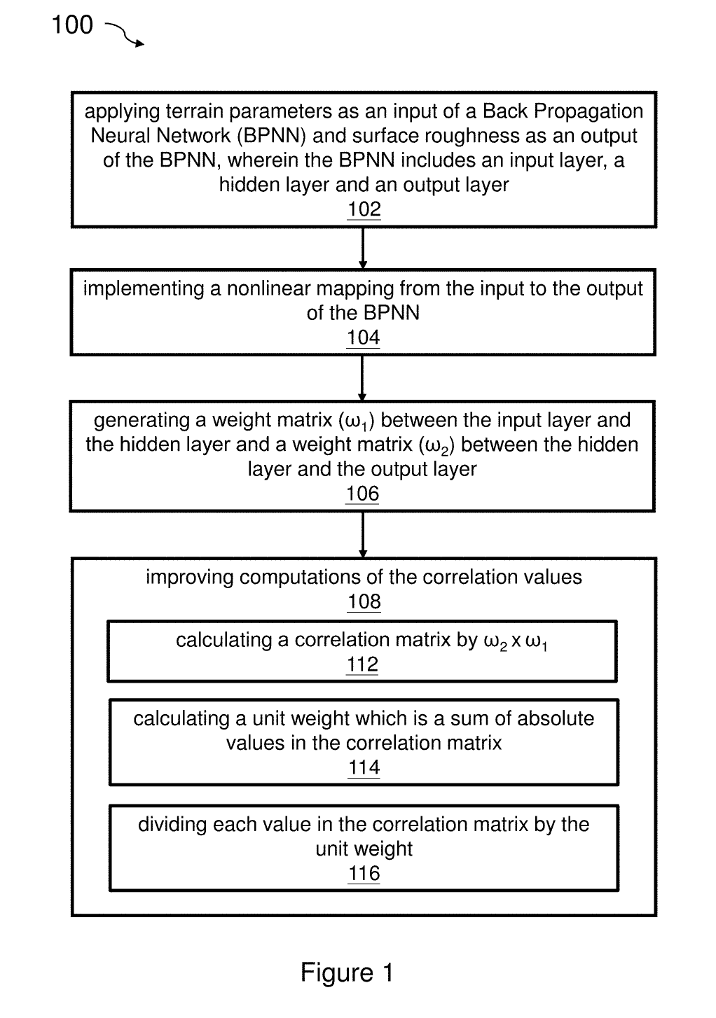

FIG. 1 shows a method executed by a computer system that improves computations of correlation values between a surface roughness and terrain parameters of a terrain surface in an example embodiment.

By way of example, the terrain parameters are selected from a group consisting of slope, aspect, curvature, plane curvature, slope variability and aspect ratio of the terrain surface.

Block 102 shows applying terrain parameters as an input of a Back Propagation Neural Network (BPNN) and surface roughness as an output of the BPNN, wherein the BPNN includes an input layer, a hidden layer and an output layer.

By way of example, the input and the output of the BPNN are normalized to be between −1 and 1.

By way of example, the surface roughness is calculated by computing a difference between generated digital elevation models and morphological closing and opening operators. The morphological closing and opening operators are constructed by finding a highest point and a lowest point reached by a Structuring Element (SE) shape.

Block 104 shows implementing a nonlinear mapping from the input to the output of the BPNN.

By way of example, an output of a j^{th} neuron of the hidden layer is expressed as Hⱼ, and a k^{th} output of the BPNN is expressed as Qₖ:

$${H}_{j} = f ( {\sum }_{i = 1}^{n} ( {ω}_{ij} - {b}_{j} ) ) , j = 1 , 2 , ⋯ , l \\ {Q}_{k} = f ( {\sum }_{j = 1}^{l} ( {ω}_{jk} - {d}_{k} ) ) , k = 1 , 2 , ⋯ , m ’$$

where f is an activation function, n, l, and m′ are the number of neurons of the input layer, the hidden layer and the output layer respectively, ωᵢⱼ is the weight matrix between the input layer and hidden layer, ωⱼₖ is the weight matrix between the hidden layer and output layer, b and d are threshold matrices of the input layer and hidden layer, and the hidden layer and the output layer, respectively.

By way of example, an error (MSE) between an actual output (Q) and an expected output (Y) of the BPNN is calculated by:

$$MSE = \frac{{Σ ( Y - Q )}^{2}}{m ’ ⋆ n}$$

where n is the dimension of the output layer and m′ is a number of neurons of the output layer.

Block 106 shows generating a weight matrix (ω₁) between the input layer and the hidden layer and a weight matrix (ω₂) between the hidden layer and the output layer.

By way of example, the BPNN is trained until the error reaches a pre-determined value by changing ω₁ and ω₂.

By way of example, the nonlinear mapping includes function f(x):

ƒ(x)=purelin[ω₂×tan sig(ω₁×X,b₁),b₂]

where tan sig has a function expressed as:

ƒ(x,ω)=(1−e^{-ωx})/(1+e^{-ωx})

where purelin has a function expressed as:

ƒ(x,ω)=ωx

where X is a matrix of six input terrain vectors:

$$X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]$$

where b₁ is a threshold matrix between the input layer and the hidden layer, b₂ is a threshold matrix between the hidden layer and the output layer, and m is the column of input layer matrix.

Block 108 shows improving computations of the correlation values.

Block 112 shows calculating a correlation matrix by ω₂×ω₁.

By way of example, the surface roughness is expressed as f(x):

$$\begin{matrix}f ( x ) = {ω}_{2} \times {ω}_{1} \times X \\ where \\ {ω}_{1} = [ \begin{matrix}{ω}_{1 , 1} & {ω}_{1 , 2} & ⋯ & {ω}_{1 , 6} \\ {ω}_{2 , 1} & {ω}_{2 , 2} & ⋯ & {ω}_{2 , 6} \\ ⋮ & ⋮ & ⋮ & ⋮ \\ {ω}_{8 , 1} & {ω}_{8 , 2} & ⋯ & {ω}_{8 , 6}\end{matrix} ] , \\ {ω}_{2} = [ \begin{matrix}{ω}_{1 , 1} & {ω}_{1 , 2} & {ω}_{1 , 3} & {ω}_{1 , 4} & {ω}_{1 , 5} & {ω}_{1 , 6} & {ω}_{1 , 7} & {ω}_{1 , 8}\end{matrix} ] ,\end{matrix}$$

By way of example, the positive and negative values of weights reflect the direction of action of the input and output factors. Negative values indicate the negative factor, and the positive value indicates the positive factor. That is, because here the absolute values of weights are needed, the positive or negative values should be processed to absolute values.

Block 114 shows calculating a unit weight which is a sum of absolute values in the correlation matrix.

Block 116 shows dividing each value in the correlation matrix by the unit weight.

By way of example, each value in the correlation matrix divided by the unit weight is expressed in relationship percentage (%) to indicate correlations between surface roughness and terrain parameters. The higher the relationship percentage, the larger the impact between surface roughness and terrain parameters.

By way of example, an improved correlation graph is generated by plotting the correlation values against the terrain parameters.

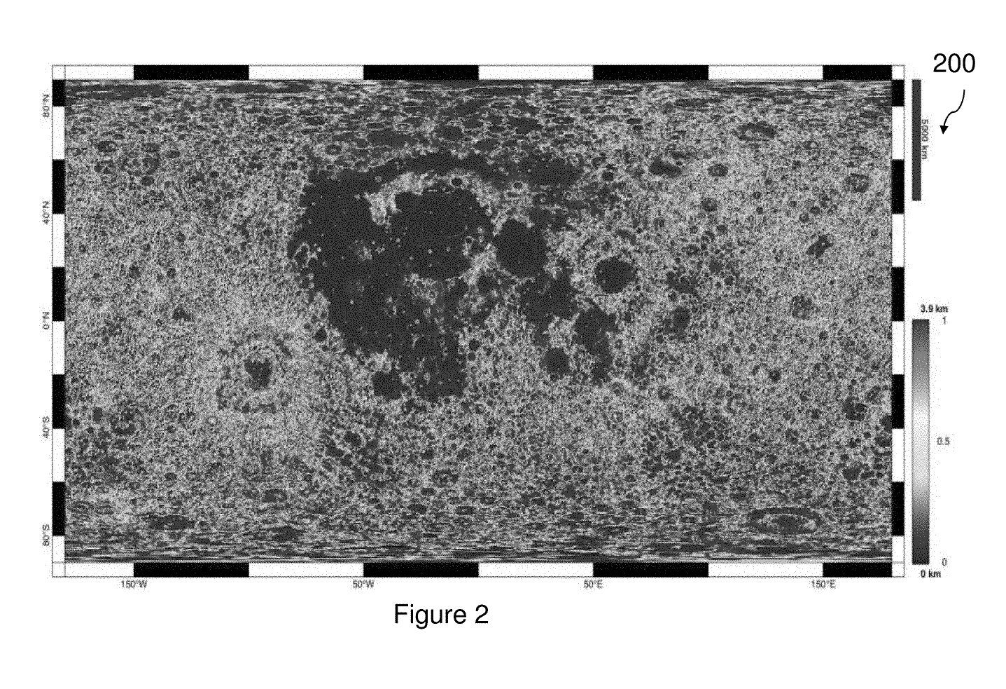

FIG. 2 shows a global roughness map with the resolution of 16 pixels per degree in an example embodiment. Surface roughness is defined as the difference of the generated DEMs with morphological closing and opening operators, which are often constructed by finding the highest and lowest points reached by a shape called Structuring Element (SE). As an important theory of geological applications, the processing of two common morphological operators: Closing and Opening are pointed out. The result of closing operator is defined as bottom hat transformation Bₕₐₜ. The operator extracts topographic lows of a surface h:

Bₕₐₜ(h)=(h·b)−h (1)

Similarly, the opening of h is defined as the top-hat transformation That and extracts the topographic highs of h:

Tₕₐₜ(h)=h−(h∘b) (2)

In Eq.1 and Eq.2, b denotes a SE. This small sets determine the calculated regions of roughness by changing their shapes and sizes. It obtains a value based on the operators and puts the changed value to the position of its origin when it slides over a calculated object. The position of origin is always the center of the SEs. Bottom-hat transformation finds the lowest value in the calculated regions and top-hat transformation is applied to extract the local highest values. It is that topographic lows are extracted by Closing operator and the topographic highs are extracted by Opening operators from original profile. Thus, the difference between the two operations is defined as surface roughness:

MSR=Bₕₐₜ(h)−Tₕₐₜ(h) (3)

Based on the Eq.3, global roughness map shown in FIG. 2 is built.

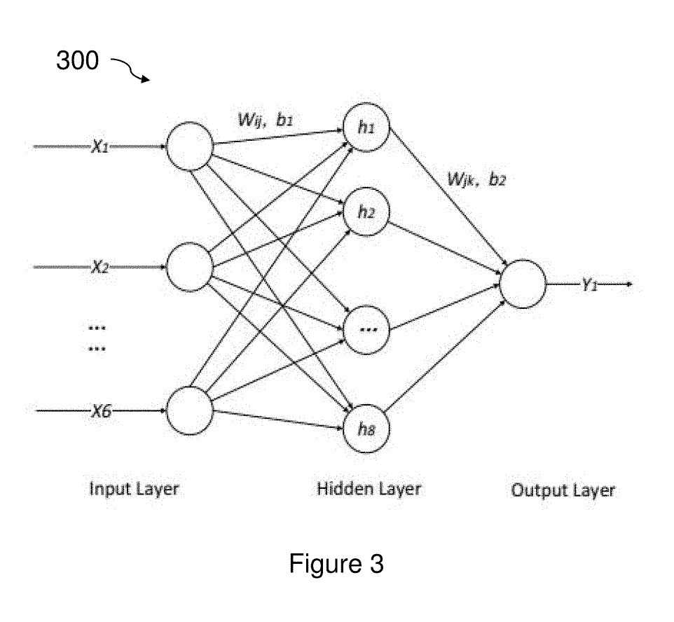

FIG. 3 shows topological structure of Back Propagation Neural Network (BPNN) including one input layer, one hidden layer or latent layer and one output layer in an example embodiment. BPNN is a kind of unidirectional propagating multi-layer forward network and a core part of the forward network. It has a high nonlinear mapping function between input and output factors, and is used in complex nonlinear function approximation. The BPNN model is adopted since the input terrain factors have a complex nonlinear relationship with the output terrain factors. According to the network mean square error (MSE), through the network learning process, a set of optimal solutions for each weight are obtained. A 3-layer neural network is enough for approximating any nonlinear function. The BP network is based on the supervised procedure, i.e. the network constructs a model based on examples of data with known output. Given a training set {X(t); Y(t)}, X(t)∈Rn, Y(t)∈Rm, t=1, 2, . . . k, where Rn is the input matrix which concludes six surface factors (slope, aspect, kv, kh, sos and soa) and Rm is output matrix i.e. surface roughness, k is a whole number of the input matrix or output matrix. BPNN can implement high nonlinear mapping from the input X(t) to the output Y(t), i.e. there exists a mapping F: Rm→Rn such that F(X(t))=Y(t). The BP algorithm is carried out as follows:

$$\begin{matrix}{H}_{j} = f ( {\sum }_{i = 1}^{n} ( {ω}_{ij} - {b}_{j} ) ) , j = 1 , 2 , . . . , l & ( 4 ) \\ {Q}_{k} = f ( {\sum }_{j = 1}^{l} ( {ω}_{jk} - {d}_{k} ) ) , k = 1 , 2 , . . . , {m}^{′} & ( 5 )\end{matrix}$$

where f is the activation function which is the selected Sigmoid function, n, l, and m′ are the number of neurons of the input layer, the hidden layer and the output layer respectively, Xᵢ is the input vector, Hⱼ is the output of the jth neuron of hidden layer, Qₖ is the kth output of the network, ωᵢⱼ is the weight matrix between the input layer and hidden layer, ωⱼₖ is the weight matrix between the hidden layer and output layer, b and d are threshold matrices of the input layer and hidden layer, and the hidden layer and the output layer, respectively. Let Y(t) be the expected output of neural network. There is an error between actual output and expected output, this error, named mean square error (MSE), can be expressed by the function:

$$MSE = \frac{\sum {( Y - Q )}^{2}}{{m}^{′} * n} \qquad ( 6 )$$

BP algorithm is a gradient descent algorithm, in which the network weights are moved along the negative of the gradient of the MSE function. Input vectors and the corresponding target vectors are used to train the network repeatedly until the error reaches the satisfaction. Once trained, the BPNN has the ability to generalize, that is, the system is able to process previously unseen data sample and to yield a probable response. Therefore, example embodiments use BPNN for solving nonlinear estimation and predictions problems.

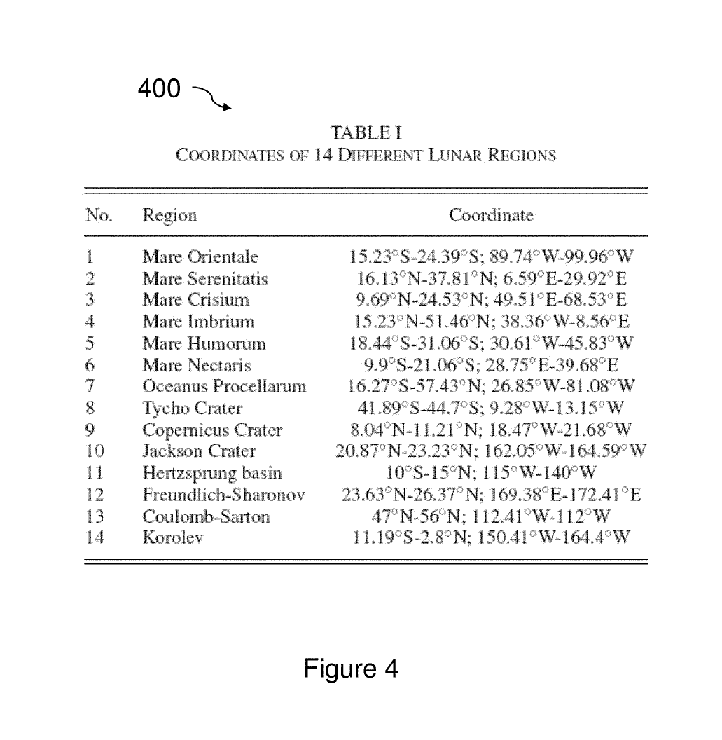

FIG. 4 shows fourteen different regions of lunar with geographical positions for sampling in an example embodiment. The fourteen regions are Mare Orientale, Mare Serenitatis, Mare Crisium, Mare Imbrium, Mare Humorum, Mare Nectaris, Oceanus Procellarum, Tycho crater, Copernicus Crater, Jackson Crater, Hertzsprung basin, Freundlich-Sharonov, Coulomb-Sarton and Korolev. Lunar Orbiter Laser Altimeter (LOLA) Gridded Data Records (GDRs) downloaded from the NASA Planetary Data System (PDS) is used as the sample data. Global products of LOLA GDRs use the equi-rectangular map projection. The terrain parameters of these regions, such as MSR, slope, aspect, curvature, plane curvature, slope variability and aspect ratio are calculated respectively based on global LOLA GDRs with resolution of 16 pixels per degree. Structuring Element (SE) is used as a scale-dependent measure in Lunar Orbiter Laser Altimeter (LOLA) Gridded Data Records (GDRs). Based on LOLA data, SE is applied to extract the concave and convex regions because the distribution of these regions indicates the surface roughness. This method's advantage is that the simple operators reduce the time of computation in huge source data.

The neural network is a multi-layer feedforward neural network trained by the error back propagation (BP) algorithm It is utilized in target identification and the information extraction. The BPNN method can be applied to invert three parameters such as mean-grain size of ice particles in snow, snow temperature and snow density. If many hidden units are provided sufficiently, one hidden layer is capable of approximating any theoretical results. Based on the Back Propagation model of neural network (BPNN), the capability of the inversion of lunar regolith layer thickness as well as the temperature profile behavior based on the satellite onboard multi-frequency radiometer data at frequencies ranging from 1 GHZ to 24 GHz is numerically studied. An efficient and accurate model with the BPNN method for using visible-near infrared reflectance spectra to estimate the abundance of minerals on the lunar surface is developed. Using BPNN method, the correlations between the ages, brightness, surface roughness, slope, (Feo+TiO2) abundance and the lunar regolith layer thickness, respectively are discussed. As an excellent nonlinear fit theory, the BPNN method is mainly to train the neural network with the input and output pairs. Once the network is trained, the desired parameters can be retrieved speedily with the inputs because it is easy to invert output parameters from input parameters.

In one or more example embodiments, six terrain parameters including slope, aspect, curvature (kv), plane curvature (kh), slope variability (SOS) and aspect ratio (SOA) are the input vectors and the surface roughness using MSR method is the output vector of the BPNN. The weights of three layers reflect the relation between the inputs and the outputs. Each terrain factor is calculated in different ways, so the data range varies widely. Before inputting the terrain factors data into the network, the input and output vectors should be normalized to eliminate the influence of the factor dimension. The “mapminmax” function is used to normalize the values of the input and output vectors to be between −1 and 1.

Slope is the incline of lunar surface. The size of the slope directly affects the surface material flow and energy conversion scale and intensity. At a given point, slope is a function of the elevation rate of the lunar surface in the east-west and north-south directions. A simplified difference formula is often used for gradient extraction as follows:

Slope=arctan \sqrt{ƒₓ²+f_{y}²}×180/Π (7)

Aspect is one of the important topographic factors that determine the local surface to receive sunlight and reallocate solar radiation. At a given point in lunar surface, the direction of the maximum change of elevation value of this point is represented by the aspect. The mathematical expression is:

Aspect=arctan(ƒ_{y}/ƒₓ) (8)

The ground curvature is a quantitative measure of a points distortion degree, which in the vertical and horizontal directions, respectively, called the plane curvature (kh) and section curvature or curvature (kv). The curvature (kv) is a measure of change rate of the ground elevation along the maximum gradient whose formula is Eq.9 and plane curvature (kh) describes the surface bending and changes along the horizontal direction whose formula is Eq.10.

$$\begin{matrix}{K}_{x} = - \frac{{p}^{2} r + 2 pqs + {q}^{2} t}{( {p}^{2} + {q}^{2} ) \sqrt{1 + {p}^{2} + {q}^{2}}} & ( 9 ) \\ {K}_{h} = - \frac{{q}^{2} r + 2 pqs + {q}^{2} t}{( {p}^{2} + {q}^{2} ) \sqrt{1 + {p}^{2} + {q}^{2}}} & ( 10 )\end{matrix}$$

In which, if H is defined as the DEM of a region, p is the height change rate in x direction, q is the change rate along y direction, r is the height change rate of p along the same direction, s is the height change rate of p along the y direction and t is the height change rate of q along the same direction. The formulas are:

$$p = \frac{\partial H}{\partial x} ; q = \frac{\partial H}{\partial y} ; r = \frac{{\partial }^{2} H}{\partial {x}^{2}} ; s = \frac{{\partial }^{2} H}{\partial x \partial y} ; t = \frac{{\partial }^{2} H}{\partial {y}^{2}} \qquad ( 11 )$$

The variability of land surface shows the variation of slope and aspect in local area, which includes slope variability SOS and aspect ratio SOA. Slope variability SOS is slope change rate in differential space.

According to the principle of slope calculation, slope of slope SOS is calculated for each point on the ground based on the extracted slope value. The slope is the solution of the rate of change of the ground elevation. Thus, the slope variability SOS represents the second derivative of the ground surface elevation relative to the horizontal change.

Aspect ratio SOA is the slope of aspect, which is based on the aspect of the slope. Aspect ratio SOS is calculated on the basis of the extracted surface slope matrix and aspect matrix, and the maximum change of slope direction in the local small area is extracted.

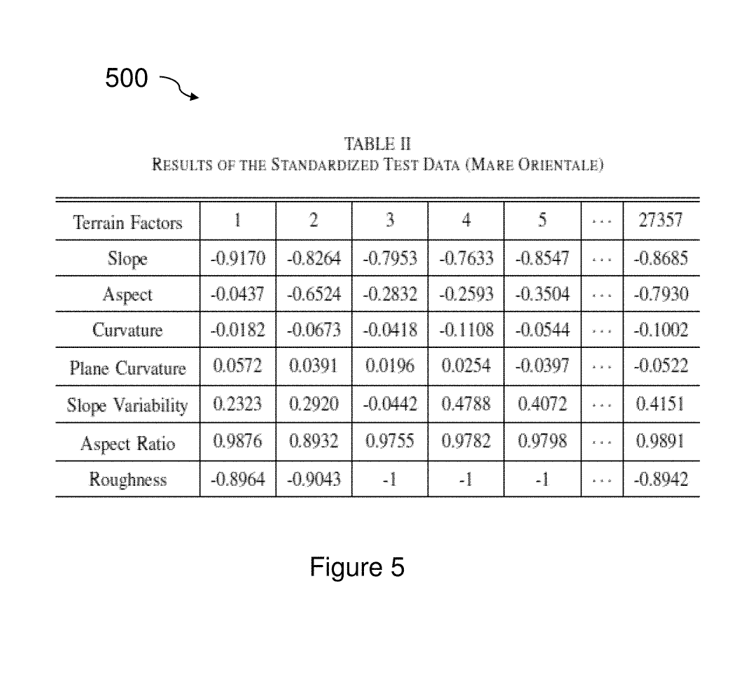

FIG. 5 shows data of Mare Orientale which is standardized and used in one example embodiment.

In one example embodiment, BPNN model which consists of one input layer, one hidden layer and one output layer is selected. The input layer and the hidden layer have a set of corresponding weights and thresholds, and there is also a corresponding set of weights and thresholds between the hidden layer and the output layer. According to the DEM data of fourteen regions, training function, prediction function, transfer function and corresponding parameters are selected. After the network structure is determined, according to the selected parameters, a network model with six input vectors and one output vector is established. Through the network training, two sets of weight relations (i.e., ω₁ and ω₂) will be gotten, then the network input and output functions can be expressed as:

ƒ(x)=purelin[ω₂×tan sig(ω₁×X,b₁),b₂] (12)

In which, the function tan sig is:

ƒ(x,ω)=(1−e^{-ωx})/(1+e^{-ωx}) (13)

whose first derivative f′(x) is:

ƒ′(x,ω)=2ωe^{-ωx}/(1+e^{-ωx})² (14)

From Eq.14, when ω<0, tan sig is a decreasing function; when ω>0, tan sig is an increasing function. The value of ω determines the rate of increasing and decreasing of tan sig function. The greater the absolute value of ω, the greater the change in the tan sig function.

The function purelin is:

ƒ(x,ω)=ωx (15)

where X represents a matrix of six input terrain victors, whose form is:

$$X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ] \qquad ( 16 )$$

weight matrix (ω₁) is the weight matrix between input layer and hidden layer:

$${ω}_{1} = [ \begin{matrix}{ω}_{1 , 1} & {ω}_{1 , 2} & ⋯ & {ω}_{1 , 6} \\ {ω}_{2 , 1} & {ω}_{2 , 2} & ⋯ & {ω}_{2 , 6} \\ ⋮ & ⋮ & ⋮ & ⋮ \\ {ω}_{8 , 1} & {ω}_{8 , 2} & ⋯ & {ω}_{8 , 6}\end{matrix} ] \qquad ( 17 )$$

weight matrix (ω₂) is the weight matrix between hidden layer and output layer:

ω₂=[ω_{1,1}ω_{1,2}ω_{1,3}ω_{1,4}ω_{1,5}ω_{1,6}ω_{1,7}ω_{1,8}] (18)

where b₁ is a threshold matrix between the input layer and the hidden layer, b₂ is a threshold matrix between the hidden layer and the output layer. Both tan sig and purelin functions are applied to each element of the matrix and do not affect the overall structure of the matrix, so the Eq.12 can be simplified as

roughnees=ƒ(x)=ω₂×ω₁×X (19)

where ω₂×ω₁ is the quantitative correlation between the roughness and the other topographic factors. The positive and negative values of weights reflect the direction of action of the input and output factors. Negative values indicate the negative factor, and the positive value indicates the positive factor. Here, the sum of the absolute values of the weights of the respective factors is taken as the unit weight.

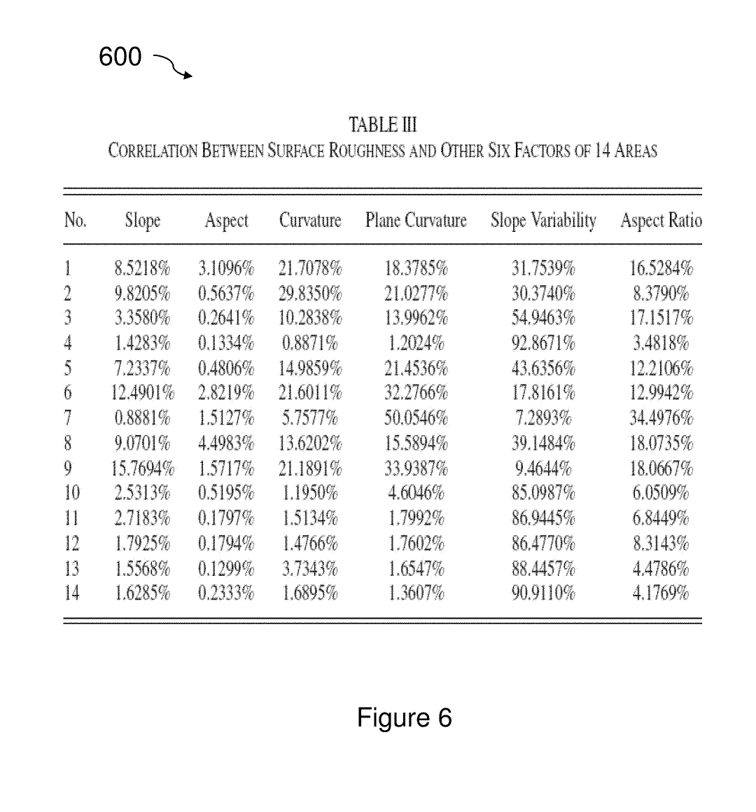

FIG. 6 shows the weights of each factor divided by the unit weight for unitization as the correlation values between each input factors and the surface roughness respectively in one example embodiment.

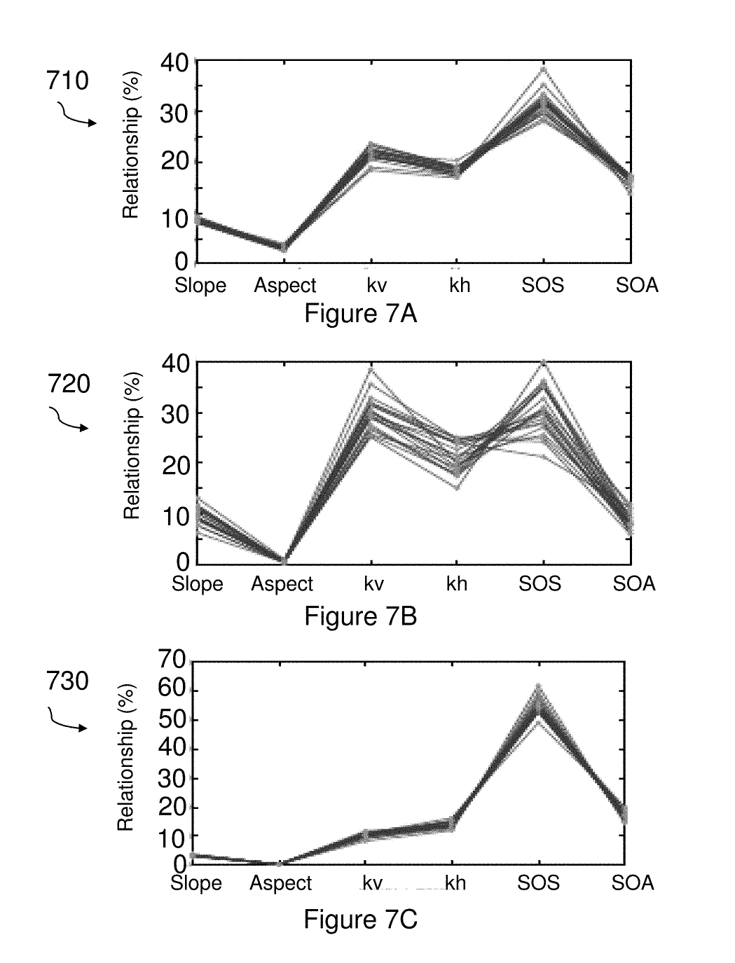

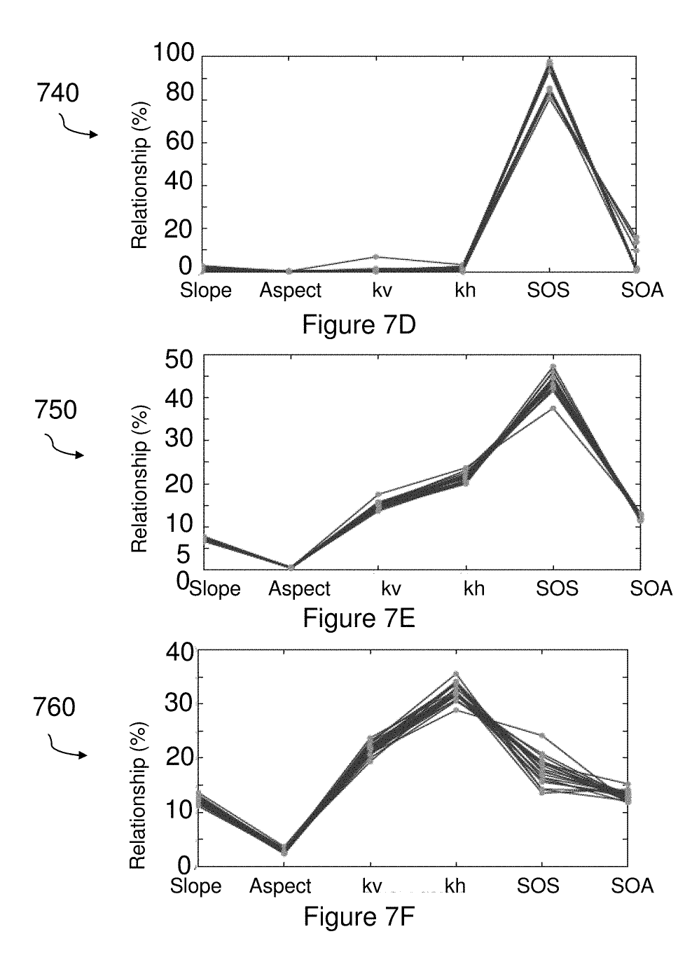

In one example embodiment, correlations values are calculated in relationship (%) and shown in FIG. 7A to FIG. 7F respectively for six lunar areas, namely Mare Orientale, Mare Serenitatis, Mare Crisium, Mare Imbrium, Mare Humorum, Mare Nectaris. The correlations between surface roughness and terrain parameters (MSR, slope, aspect, curvature, plane curvature, slope variability and aspect ratio) are shown by plotting the correlations values against the terrain parameters. FIG. 7A, FIG. 7B show same relationship trend that kv and SOS are the largest impact factor while aspect is the smallest impact factor. As a result, Mare Orientale and Mare Serenitatis have the same topographic features.

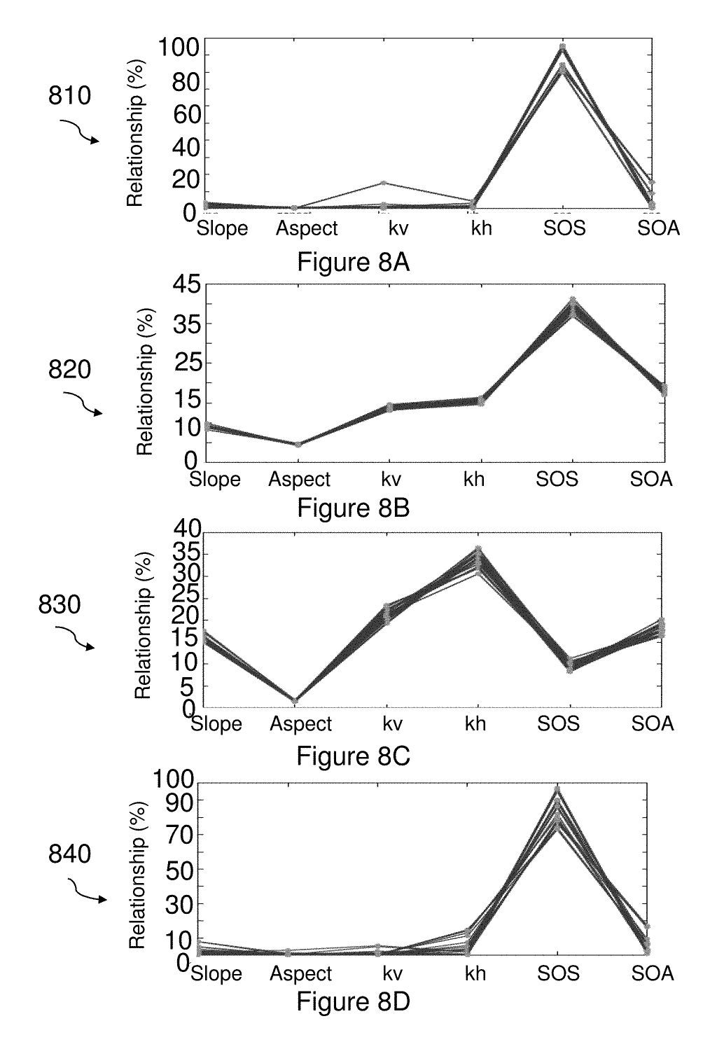

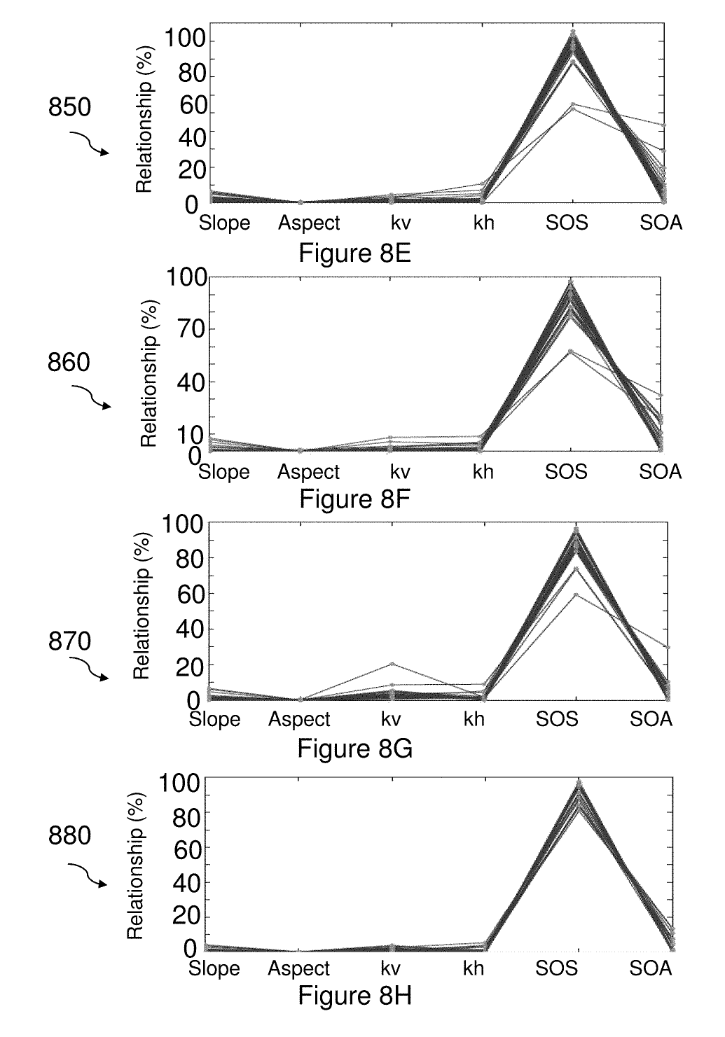

In the example embodiment, correlations values are calculated in relationship (%) and shown in FIG. 8A to FIG. 8H respectively for eight lunar areas, namely Oceanus Procellarum, Tycho Crater, Copernicus Crater, Jackson Crater, Hertzsprung Basin, Freundlich-Sharonov, Coulomb-Sarton and Korolev. The correlations between surface roughness and terrain parameters (MSR, slope, aspect, curvature, plane curvature, slope variability and aspect ratio) are shown by plotting the correlations values against the terrain parameters. FIG. 7D, FIG. 8A, FIG. 8D, FIG. 8E, FIG. 8F, FIG. 8G and FIG. 8H show the same relationship trend that SOS is the most closely related to the lunar surface roughness, while other land-surface parameters are not very prominent. In addition, these seven areas have the similar topographic features.

FIG. 7C, FIG. 7D and FIG. 8B show same relationship trend that SOS has the greatest effect on the lunar surface roughness, and aspect has the smallest effect on land-surface parameter.

FIG. 7F and FIG. 8C show same relationship trend that slope has the greatest effect on the surface roughness and aspect is the smallest impact land-surface parameter in the example embodiment. As a result, Mare Nectaris and Copernicus Crater have the same topographic features.

Based on the improved correlation graphs shown in FIG. 7A to FIG. 7F, and FIG. 8A to FIG. 8H, there are clear correlations between surface roughness and terrain parameters although the relationships of different areas are different. For the fourteen areas, slope, curvature kv, slope variability SOS are the three largest impact factors and aspect is the smallest impact factor with the surface roughness.

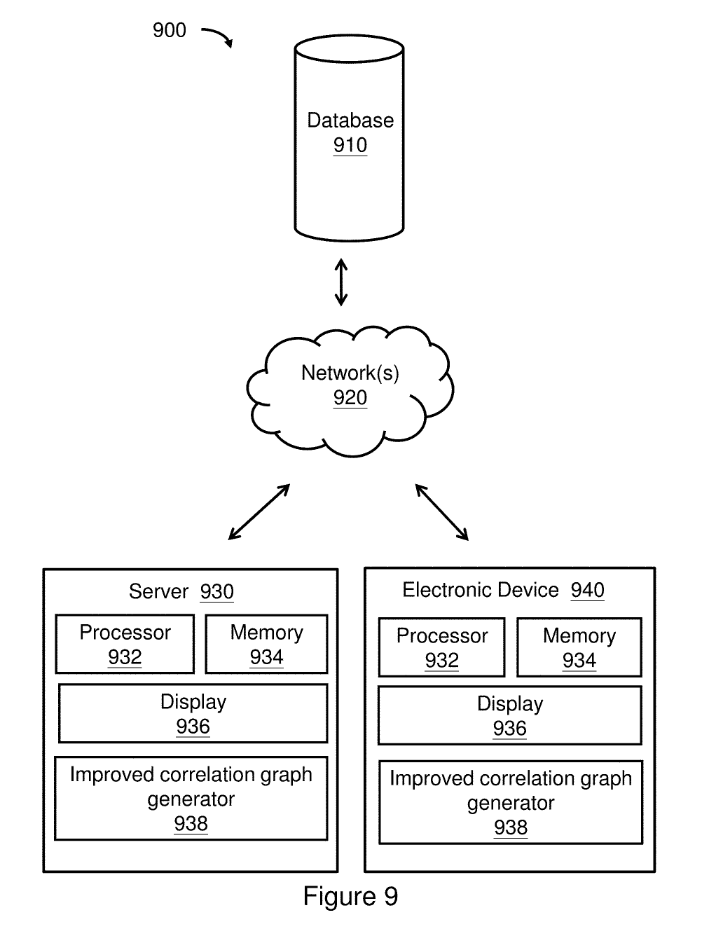

FIG. 9 shows a computer system that executes and generates an improved correlation graph that shows correlations between a surface roughness and terrain parameters of a lunar surface. The computer system includes one or more of a server 930, electronic device 940 and database 910 in communication via one or more networks 920.

The server 930 includes a processor or processing unit 932, a memory 934, a display 936, and improved correlation graph generator 938.

The electronic device 940 includes one or more of a processor or processing unit 932, memory 934, display 936 and improved correlation graph generator 938. Examples of an electronic device include, but are not limited to, laptop computers, desktop computers, tablet computers, handheld portable, electronic devices (HPEDs), and other portable and non-portable electronic devices.

The database 910 includes electronic storage or memory and can store data or other information to assist in executing example embodiments.

The network(s) 920 can include one or more of a wired network or wireless network, such as the internet, cellular network, etc.

The processor, memory, and/or improved correlation graph generator in the server 930 and/or electronic device 940 execute methods in accordance with example embodiments. The improved correlation graph generator can include software and/or specialized hardware to execute example embodiments.

The processor unit includes a processor (such as a central processing unit, CPU, microprocessor, microcontrollers, field programmable gate array (FPGA), application-specific integrated circuit (ASIC), etc.) for controlling the overall operation of memory (such as random access memory (RAM) for temporary data storage, read only memory (ROM) for permanent data storage, and firmware). The processing unit and improved map generator communicate with each other and memory and perform operations and tasks that implement one or more blocks of the flow diagrams discussed herein. The memory, for example, stores applications, data, programs, algorithms (including software to implement or assist in implementing example embodiments) and other data.

In some example embodiments, the methods illustrated herein and data and instructions associated therewith are stored in respective storage devices, which are implemented as computer-readable and/or machine-readable storage media, physical or tangible media, and/or non-transitory storage media. These storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed and removable disks; other magnetic media including tape; optical media such as Compact Disks (CDs) or Digital Versatile Disks (DVDs). Note that the instructions of the software discussed above can be provided on computer-readable or machine-readable storage medium, or alternatively, can be provided on multiple computer-readable or machine-readable storage media distributed in a large system having possibly plural nodes. Such computer-readable or machine-readable medium or media is (are) considered to be part of an article (or article of manufacture). An article or article of manufacture can refer to any manufactured single component or multiple components.

Blocks and/or methods discussed herein can be executed and/or made by a user, a user agent (including machine learning agents and intelligent user agents), a software application, an electronic device, a computer, firmware, hardware, a process, a computer system, and/or an intelligent personal assistant. Furthermore, blocks and/or methods discussed herein can be executed automatically with or without instruction from a user.

The methods in accordance with example embodiments are provided as examples, and examples from one method should not be construed to limit examples from another method. Further, methods discussed within different figures can be added to or exchanged with methods in other figures. Further yet, specific numerical data values (such as specific quantities, numbers, categories, etc.) or other specific information should be interpreted as illustrative for discussing example embodiments. Such specific information is not provided to limit example embodiments.

As used herein, “the “mapminmax” function is a function defined in MATLAB R2014b version.

1. A method executed by a computer system that improves computations of correlation values between a surface roughness and terrain parameters of a terrain surface, the method comprising:
applying, by the computer system, the terrain parameters as an input of a Back Propagation Neural Network (BPNN) and the surface roughness as an output of the BPNN, wherein the BPNN includes an input layer, a hidden layer and an output layer;
implementing, by the computer system, a nonlinear mapping from the input to the output of the BPNN;
generating, by the computer system, a weight matrix (ω₁) between the input layer and the hidden layer and a weight matrix (ω₂) between the hidden layer and the output layer; and
improving computations of the correlation values by:
calculating, by the computer system, a correlation matrix by ω₂×ω₁;
calculating, by the computer system, a unit weight which is a sum of absolute values in the correlation matrix; and
dividing, by the computer system, each value in the correlation matrix by the unit weight.

2. The method of claim 1, wherein the terrain parameters are selected from a group consisting of slope, aspect, curvature, plane curvature, slope variability and aspect ratio of the terrain surface.

3. The method of claim 1 further comprising:
normalizing the input and the output of the BPNN to be between −1 and 1.

4. The method of claim 1 further comprising
calculating, by the computer system, an error (MSE) between an actual output (Q) and an expected output (Y) of the BPNN by:
$$MSE = \frac{{Σ ( Y - Q )}^{2}}{m ’ ⋆ n}$$
wherein where n is the dimension of the output layer and m′ is a number of neurons of the output layer; and
training, by the computer system, the BPNN until the error reaches a pre-determined value by changing ω₁ and ω₂.

5. The method of claim 1, wherein the nonlinear mapping includes function f(x):
ƒ(x)=purelin[ω₂×tan sig(ω₁×X,b₁),b₂]
wherein tan sig has a function expressed as:
ƒ(x,ω)=(1−e^{-ωx})/(1+e^{-ωx})
wherein purelin has a function expressed as:
ƒ(x,ω)=ωx
where X is a matrix of six input terrain vectors:
$$X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]$$
where b₁ is a threshold matrix between the input layer and the hidden layer, b₂ is a threshold matrix between the hidden layer and the output layer and m is the column of input layer matrix.

6. The method of claim 1, wherein the surface roughness is expressed as f(x):
$$\begin{matrix}f ( x ) = {ω}_{2} \times {ω}_{1} \times X \\ where \\ {ω}_{1} = [ \begin{matrix}{ω}_{1 , 1} & {ω}_{1 , 2} & ⋯ & {ω}_{1 , 6} \\ {ω}_{2 , 1} & {ω}_{2 , 2} & ⋯ & {ω}_{2 , 6} \\ ⋮ & ⋮ & ⋮ & ⋮ \\ {ω}_{8 , 1} & {ω}_{8 , 2} & ⋯ & {ω}_{8 , 6}\end{matrix} ] , \\ {ω}_{2} = [ \begin{matrix}{ω}_{1 , 1} & {ω}_{1 , 2} & {ω}_{1 , 3} & {ω}_{1 , 4} & {ω}_{1 , 5} & {ω}_{1 , 6} & {ω}_{1 , 7} & {ω}_{1 , 8}\end{matrix} ] , \\ X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]\end{matrix}$$
and m is the column of input layer matrix.

7. The method of claim 1, wherein an output of a j^{th} neuron of the hidden layer is expressed as Hⱼ, and a k^{th} output of the BPNN is expressed as Qₖ:
$${H}_{j} = f ( {\sum }_{i = 1}^{n} ( {ω}_{ij} - {b}_{j} ) ) , j = 1 , 2 , ⋯ , l \\ {Q}_{k} = f ( {\sum }_{j = 1}^{l} ( {ω}_{jk} - {d}_{k} ) ) , k = 1 , 2 , ⋯ , m ’$$
where f is an activation function, n, l, and m′ are the number of neurons of the input layer, the hidden layer and the output layer respectively, ωᵢⱼ is a weight matrix between the input layer and hidden layer, ωⱼₖ is a weight matrix between the hidden layer and output layer, b and d are threshold matrices of the input layer and hidden layer, and the hidden layer and the output layer, respectively.

8. The method of claim 1 further comprising:
calculating, by the computer system, the surface roughness by computing a difference between generated digital elevation models and morphological closing and opening operators, wherein the morphological closing and opening operators are constructed by finding a highest point and a lowest point reached by a Structuring Element (SE) shape.

9. A computer system that generates an improved correlation graph that shows correlations between a surface roughness and terrain parameters of a lunar surface, the computer system comprising:
a processor;
a display;
a non-transitory computer-readable medium having stored therein instructions that when executed cause the processor to:
apply the terrain parameters as an input of a Back Propagation Neural Network (BPNN) and the surface roughness as an output of the BPNN, wherein the BPNN includes an input layer, a hidden layer and an output layer;
implement a nonlinear mapping from the input to the output of the BPNN;
generate a weight matrix (ω₁) between the input layer and the hidden layer and a weight matrix (ω₂) between the hidden layer and the output layer;
compute correlation values by:
calculating a correlation matrix by ω₂×ω₁;
calculating a unit weight which is a sum of absolute values in the correlation matrix; and
dividing each value in the correlation matrix by the unit weight; and
generate the improved correlation graph on the display by plotting the correlation values against the terrain parameters.

10. The system of claim 9, wherein the terrain parameters are selected from a group consisting of slope, aspect, curvature, plane curvature, slope variability and aspect ratio of the lunar surface.

11. The system of claim 9, wherein the instructions when executed further cause the processor to
calculate an error (MSE) between an actual output (Q) and an expected output (Y) of the BPNN by:
$$MSE = \frac{{Σ ( Y - Q )}^{2}}{m ’ ⋆ n}$$
wherein n is the dimension of the output layer and m′ is a number of neurons of the output layer; and
train the BPNN until the error reaches a pre-determined value by changing ω₁ and ω₂.

12. The system of claim 9, wherein the nonlinear mapping includes function f(x):
ƒ(x)=purelin[ω₂×tan sig(ω₁×X,b₁),b₂]
wherein tan sig has a function expressed as:
ƒ(x,ω)=(1−e^{-ωx})/(1+e^{-ωx})
wherein purelin has a function expressed as:
ƒ(x,ω)=ωx
where X is a matrix of six input terrain vectors:
$$X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]$$
where b₁ is a threshold matrix between the input layer and the hidden layer, b₂ is a threshold matrix between the hidden layer and the output layer and m is the column of input layer matrix.

13. The system of claim 9, wherein the surface roughness is expressed as f(x):
$$\begin{matrix}f ( x ) = {ω}_{2} \times {ω}_{1} \times X \\ where \\ {ω}_{1} = [ \begin{matrix}{ω}_{1 , 1} & {ω}_{1 , 2} & ⋯ & {ω}_{1 , 6} \\ {ω}_{2 , 1} & {ω}_{2 , 2} & ⋯ & {ω}_{2 , 6} \\ ⋮ & ⋮ & ⋮ & ⋮ \\ {ω}_{8 , 1} & {ω}_{8 , 2} & ⋯ & {ω}_{8 , 6}\end{matrix} ] , \\ {ω}_{2} = [ \begin{matrix}{ω}_{1 , 1} & {ω}_{1 , 2} & {ω}_{1 , 3} & {ω}_{1 , 4} & {ω}_{1 , 5} & {ω}_{1 , 6} & {ω}_{1 , 7} & {ω}_{1 , 8}\end{matrix} ] , \\ X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]\end{matrix}$$
and m is the column of input layer matrix.

14. A method that generates an improved correlation graph that shows correlations between a surface roughness and terrain parameters of a lunar surface, the method comprising:
applying, by the computer system, the terrain parameters as an input of a Back Propagation Neural Network (BPNN) and the surface roughness as an output of the BPNN, wherein the BPNN includes an input layer, a hidden layer and an output layer;
implementing, by the computer system, a nonlinear mapping from the input to the output of the BPNN;
generating, by the computer system, a weight matrix (ω₁) between the input layer and the hidden layer and a weight matrix (ω₂) between the hidden layer and the output layer;
computing, by the computer system, correlation values by:
calculating a correlation matrix by ω₂×ω₁;
calculating a unit weight which is a sum of absolute values in the correlation matrix;
dividing each value in the correlation matrix by the unit weight; and
generating, by the computer system and on a display, the improved correlation graph by plotting the correlation values against the terrain parameters.

15. The method of claim 14, wherein the terrain parameters are selected from a group consisting of slope, aspect, curvature, plane curvature, slope variability and aspect ratio of the lunar surface.

16. The method of claim 14 further comprising:
normalizing the input and the output of the BPNN to be between −1 and 1.

17. The method of claim 14 further comprising,
calculating, by the computer system, an error (MSE) between an actual output (Q) and an expected output (Y) of the BPNN by:
$$MSE = \frac{{Σ ( Y - Q )}^{2}}{m ’ ⋆ n}$$
wherein n is the dimension of the output layer and m′ is a number of neurons of the output layer; and
training, by the computer system, the BPNN until the error reaches a pre-determined value by changing ω₁ and ω₂.

18. The method of claim 14, wherein the nonlinear mapping includes function f(x):
ƒ(x)=purelin[ω₂×tan sig(ω₁×X,b₁),b₂]
wherein tan sig has a function expressed as:
ƒ(x,ω)=(1−e^{-ωx})/(1+e^{-ωx})
wherein purelin has a function expressed as:
ƒ(x,ω)=ωx
where X is a matrix of six input terrain vectors:
$$X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]$$
where b1 is a threshold matrix between the input layer and the hidden layer, b2 is a threshold matrix between the hidden layer and the output layer.

19. The method of claim 14, wherein the surface roughness is expressed as f(x):
$$\begin{matrix}f ( x ) = {ω}_{2} \times {ω}_{1} \times X \\ where \\ {ω}_{1} = [ \begin{matrix}{ω}_{1 , 1} & {ω}_{1 , 2} & ⋯ & {ω}_{1 , 6} \\ {ω}_{2 , 1} & {ω}_{2 , 2} & ⋯ & {ω}_{2 , 6} \\ ⋮ & ⋮ & ⋮ & ⋮ \\ {ω}_{8 , 1} & {ω}_{8 , 2} & ⋯ & {ω}_{8 , 6}\end{matrix} ] , \\ {ω}_{2} = [ \begin{matrix}{ω}_{1 , 1} & {ω}_{1 , 2} & {ω}_{1 , 3} & {ω}_{1 , 4} & {ω}_{1 , 5} & {ω}_{1 , 6} & {ω}_{1 , 7} & {ω}_{1 , 8}\end{matrix} ] , \\ X = [ \begin{matrix}{x}_{1 , 1} & {x}_{1 , 2} & ⋯ & {x}_{1 , m} \\ {x}_{2 , 1} & {x}_{2 , 2} & ⋯ & {x}_{2 , m} \\ ⋮ & ⋮ & ⋮ & ⋮ \\ {x}_{6 , 1} & {x}_{6 , 2} & ⋯ & {x}_{6 , m}\end{matrix} ]\end{matrix}$$
and m is the column of input layer matrix.

20. The method of claim 14 further comprising:
calculating, by the computer system, the surface roughness by computing a difference between generated digital elevation models and morphological closing and opening operators, wherein the morphological closing and opening operators are constructed by finding a highest point and a lowest point reached by a Structuring Element (SE) shape.
